(19) United States
(12) Patent Application Publication
(10) Pub. No.: US 2019/0004244 A1
(43) Pub. Date: Jan. 3, 2019

(54) LIQUID CRYSTAL DISPLAY, BACKLIGHT MODULE AND METHOD FOR ASSEMBLING THE SAME

(71) Applicant: WUHAN CHINA STAR OPTOELECTRONICS TECHNOLOGY CO., LTD., Wuhan, Hubei (CN)

(72) Inventor: Qian Chen, Hubei, Wuhan (CN)

(21) Appl. No.: 15/566,941

(22) PCT Filed: Aug. 2, 2017
(86) PCT No.: PCT/CN2017/095610

§ 371 Date: Oct. 16, 2017

(30) Foreign Application Priority Data
Jun. 30, 2017 (CN) 201710522664.8

(51) Int. Cl. F21V 8/00

(52) U.S. Cl. CPC G02B 6/0088; G02B 6/005; G02B 6/0065; G02B 6/0073; G02B 6/0068

(57) ABSTRACT

The present application provides a liquid crystal display, a backlight module and a methods for assembling the same. The backlight module includes a back plate, a light guide plate, an optical film group and a light source. The back plate includes a bottom plate, and the light guide plate and the optical film group are sequentially disposed on the bottom plate from bottom to top. The light source includes a number of LED lamps disposed on the bottom plate and opposite to a light entrance surface of the light guide plate. One surface of the bottom plate facing the light guide plate is coated with a reflective material. The back plate of the backlight module according to the present application includes a bottom plate and one surface of the bottom plate facing the light guide plate is coated with a reflective material.

### TECHNICAL FIELD

The present application generally relates to liquid crystal displays and, more particularly, relates to a liquid crystal display, a backlight module and a method for assembling the same.

### RELATED ART

With the development of the liquid crystal display technology, flat panel display devices, especially the liquid crystal display devices, have been widely used in various fields. The liquid crystal display devices have replaced the traditional cathode ray tube display devices due to lightweight, low power consumption and space saving. As a passive display technology, a liquid crystal display requires the light to penetrate the liquid crystal layer, so that a human eye can observe the image character information of the liquid crystal layer. Therefore, a backlight module is required to provide a light source for the liquid crystal display device. A conventional backlight module generally includes a light guide plate, a rubber frame, a reflector, an optical film group, a light source and a back plate. However, the structure of a conventional backlight module is complex, and the assembly time is long.

### SUMMARY

One object of the present application is to provide a liquid crystal display, a backlight module and a method for assembling the same, wherein the backlight module has simple structure, light weight and short assembly time.

According to one embodiment of the present invention, a backlight module includes a back plate, a light guide plate, an optical film group and a light source. The back plate includes a bottom plate. The light guide plate and the optical film group are sequentially disposed on the bottom plate from bottom to top. The light source includes a number of LED lamps disposed on the bottom plate and opposite to a light entrance surface of the light guide plate. One surface of the bottom plate facing the light guide plate is coated with a reflective material.

Optionally, the back plate further includes a side plate extending upwardly from the bottom plate. One side of the side plate afar from the light entrance surface of the light guide plate has an opening shape.

Optionally, the back plate further includes a top plate extending from the side plate towards the optical film group. The top plate extends to one edge of the optical film group and fits to an upper surface of the optical film group.

Optionally, surfaces of the side plate and the top plate facing the light guide plate are coated with shading material.

Optionally, the backlight module further includes a rubber strip disposed on the bottom plate. The rubber strip and the light source are disposed at two opposite sides of the light guide plate respectively.

Optionally, the rubber strip includes a vertical portion perpendicular to the bottom plate and a horizontal portion extending from the vertical portion towards the optical film group. The horizontal portion extends to the edge of the optical film group and is attached to the upper surface of the optical film group.

Optionally, the side plate is provided with a fixing hole, the vertical portion is formed with a bump corresponding to the fixing hole, and the rubber strip and the side plate are fixed by the bump and the fixing hole.

Optionally, a number of baffles are disposed at intervals on the light entrance surface of the light guide plate. The baffles and the side plate jointly define a number of placing slots. The LED lamps are correspondingly accommodated in the placing slots.

One embodiment of the present invention also provides a method for assembling a backlight module, including the steps of:

attaching the light source and the optical film group to the light guide plate to form a first component; and;

inserting the first component into the back plate from one side of the back plate having the opening shape to form the backlight module.

One embodiment of the present invention also provides a liquid crystal display including a display module and a backlight module as described above. The display module is positioned above the optical film group.

The backlight module according to the present invention includes a back plate, a light guide plate, an optical film group and a light source. The back plate includes a bottom plate. The bottom plate is coated with a reflective material on one surface thereof facing the light guide plate. The backlight module according to the present invention can replace conventional a backlight module having a reflector via coating reflective material on the surface of the bottom plate, thereby simplifying the structure, reducing the weight and shortening the assembly time.

### BRIEF DESCRIPTION OF THE DRAWINGS

FIG. 1 depicts a structure diagram of a liquid crystal display;

FIG. 2 depicts another structure diagram of a liquid crystal display;

FIG. 3 depicts a structure diagram of a back plate;

FIG. 4 depicts yet another structure diagram of a liquid crystal display;

FIG. 5 depicts a structure diagram of a back plate and a rubber strip; and

FIG. 6 depicts a structure diagram of a light guide plate.

### DETAILED DESCRIPTION OF EMBODIMENTS

The present invention will now be described in more detail with reference to the accompanying drawings and exemplary embodiments. Indeed, the present invention may be embodied in many different forms and should not be construed as limited to the embodiments set forth herein. Rather, these embodiments are provided to explain the principles of the present invention and practical applications thereof, so that those skilled in the art can understand various embodiments of the present invention and various modifications thereof. In the drawings, like reference numerals refer to like elements throughout.

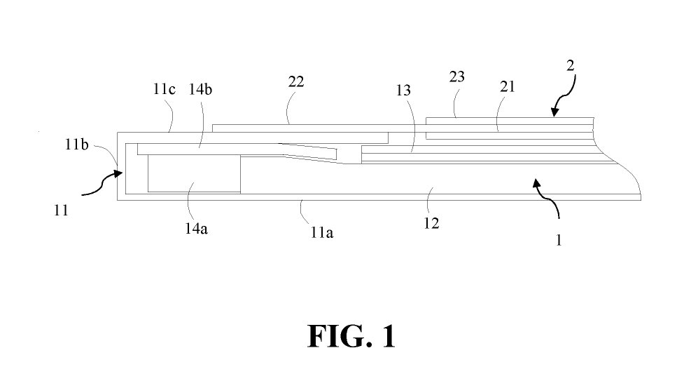

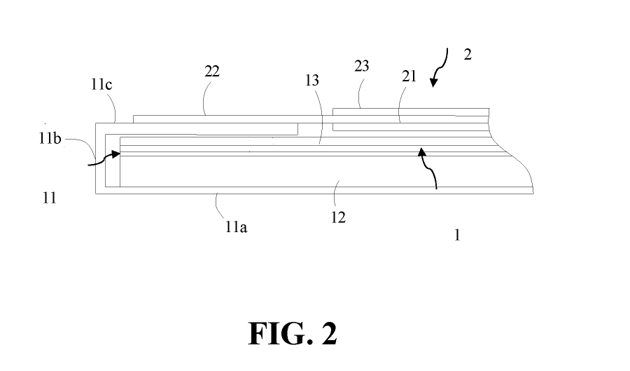

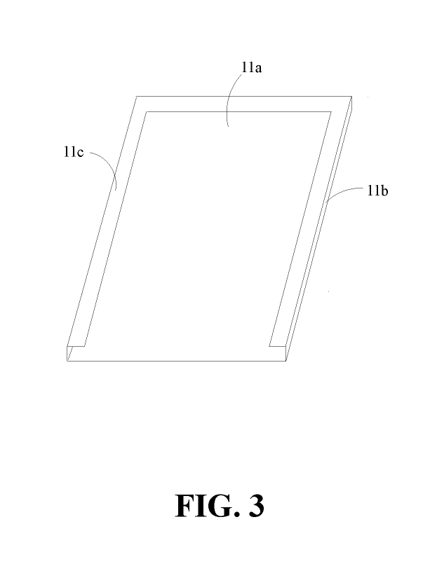

Referring to FIGS. 1 to 3, a liquid crystal display according to one embodiment of the present embodiment includes a backlight module 1 and a display module 2. The backlight module 1 is configured to provide a light source 14 for the display module 2. The display module 2 is configured for displaying the images. Specifically, the backlight module 1 includes a back plate 11, a light guide plate 12, an optical film group 13 and a light source 14. The back plate 11 includes a bottom plate 11a. The light guide plate 12 and the optical film group 13 are sequentially disposed on the bottom plate 11a from bottom to top. The light source 14 includes a number of LED lamps 14a disposed on the bottom plate 11a and opposite to a light entrance surface of the light guide plate 12. One surface of the bottom plate 11a facing the light guide plate 12 is coated with a reflective material.

The backlight module 1 according to the present embodiment is an edge type backlight module. Side surface of the light guide plate 12 is the light entrance surface. The light beam emitted by the LED lamp 14a enters into the light guide plate 12 from the light entrance surface, and can be reflected for multiple times within the light guide plate 12 before being emitted uniformly from the top of the light guide plate 12. The light beam incident on the bottom of the light guide plate 12 is reflected by the reflective material on the surface of the back plate 11 and reflected into the light guide plate 12. Therefore, the backlight module 1 according to the present embodiment eliminates the reflector of the traditional backlight modules, thereby simplifying the structure, reducing the weight, and shorting the assembly time.

The back plate 11 further includes a side plate 11b extending upwardly from the bottom plate 11a. The LED lamp 14a is arranged between the side plate 11b and the light guide plate 12. The side plate 11b is arranged around the light guide plate 12 and the light source 14. One side of the side plate 11b afar from the light entrance surface of the light guide plate 12 is configured in an opening shape.

The back plate 11 further includes a top plate 11c extending towards the optical film group 13 from the side plate 11b. The top plate 11c extends to an edge of the optical film group 13, and fits to an upper surface of the optical film group 13. The top plate 11c, the side plate 11b, the bottom plate 11a, the light guide plate 12 and the optical film group 13 cooperatively define a receiving space for accommodating the light source 14. The back plate 11 according to the present embodiment is made from metal. The back plate 11 is connected to the circuit of the display module 2, so that the static electricity on the display module 2 can be released, so as to prevent the static electricity from damaging the circuit of the display module 2.

According to the present embodiment, the surfaces of the side plate 11b and the top plate 11c facing the light guide plate 12 are coated with a light shielding material. In other words, light shielding material is coated on inner side of the side plate 11b and the top plate 11c. By coating the light shielding material on the inner side of the side plate 11b, the side plate 11b has the function as that of a rubber frame in a conventional backlight module. By coating the light shielding material on the inner side of the top plate 11c, the top plate 11c has the function as that of a light blocking adhesive layer in a conventional backlight module. Therefore, the backlight module 1 according to the present embodiment eliminates the rubber frame and the light shielding rubber strip 15 of the traditional backlight module, thereby simplifying the structure and reducing the weight.

The light source 14 according to the present embodiment further includes a base plate 14b. A number of LED lamps 14a are respectively disposed on the base plate 14b and electrically connected to the base plate 14b. The base plate 14b is FPC, which is disposed between the top plate 11c and the LED lamps 14a. Preferably, the base plate 14b completely covers the LED lamps 14a and extends to the edge of the light guide plate 12, and fits to an upper surface of the light guide plate 12. Extending the base plate 14b to the surface of the light guide plate 12 not only can improve the heat dissipation effect of the LED lamp 14a, but also can play the role of shading.

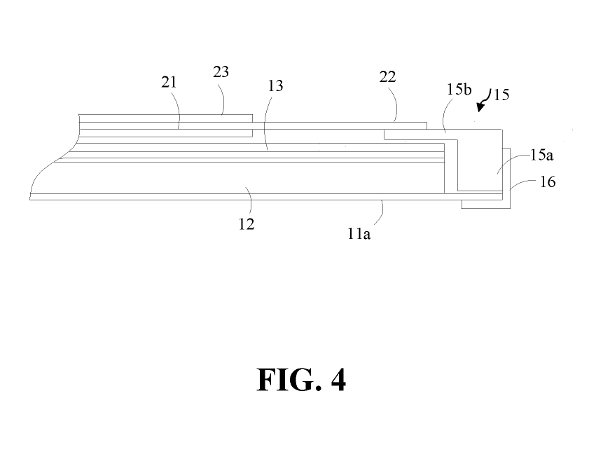

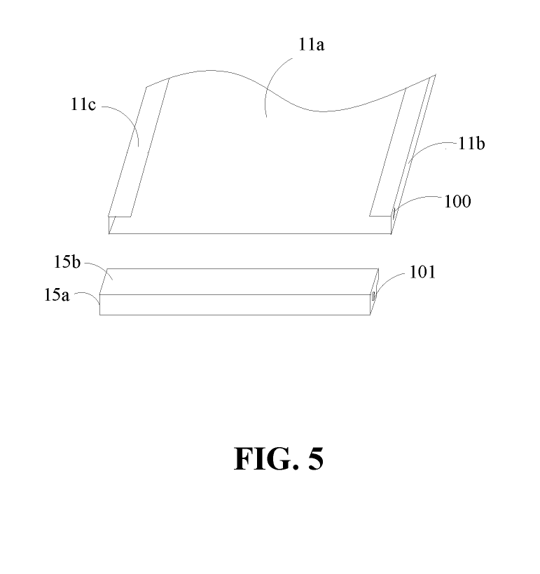

Referring to FIGS. 4 and 5, in order to enhance the strength of the backlight module 1, the backlight module 1 further includes a rubber strip 15 disposed on the bottom plate 11a. The rubber strip 15 and the light source 14 are disposed at two opposite sides of the light guide plate 12 respectively, i.e., the rubber strip 15 is disposed at one side of the side plate 11b having the opening shape. The rubber strip 15 includes a vertical portion 15a perpendicular to the bottom plate 11a and a horizontal portion 15b extending from the vertical portion 15a towards the optical film group 13. The horizontal portion 15b extends to the edge of the optical film group 13 and attaches to an upper surface of the optical film group 13.

The rubber strip 15 is made from opaque material and is configured to support the optical film group 13 and fix the optical film group 13 to the backing plate 11. In order to avoid light leakage, a light blocking adhesive tape 16 is adhered to the outside of the vertical portion 15a and the bottom of the bottom plate 11a, so that the light emitted from the gap between the vertical portion 15a and the bottom plate 11a can be blocked by the light blocking adhesive tape 16.

For easy assembly, a fixing hole 100 is disposed at one end of the side plate 11b having the opening shape. A bump 101 corresponding to the fixing hole 100 is formed on the vertical portion 15a. Preferably, the side plate 11b is provided with two fixing holes 100 at two sides of the light guide plate 12. Correspondingly, there are two bumps 101 at two sides of the vertical portion 15a. Since the rubber strip 15 has elasticity, during the assembling process, the rubber strip 15 and the side plate 11b can be fixed to each other by engaging the bump 101 with the fixing hole 100.

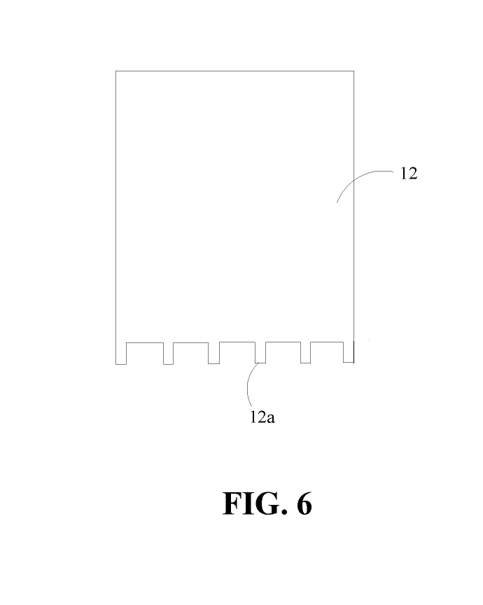

Referring to FIG. 6, a number of baffles 12a are disposed at intervals on the light entrance surface of the light guide plate 12. A number of placing slots are jointly enclosed by the number baffles 12 and the side plate 11b. The LED lamps 14a are correspondingly accommodated in the placing slots. Preferably, the number of baffles 12a according to the present embodiment are arranged at equal intervals on the light entrance surface.

One embodiment according to the present invention further provides a method for assembling a backlight module 1 as described above, the method including the steps of:

Step S1, attaching the light source 14 and the optical film group 13 to the light guide plate 12 respectively to form a first component;

Step S2, inserting the first assembly into the back plate 11 from one side of the back plate 11 having the opening shape to form the backlight module 1.

Specifically, the first component is inserted into the back plate 11 from one side of the back plate 11 having the opening shape. Step S2 further includes inserting the strip 15 from one side of the back plate 11 having the opening shape, so that the bump 101 of the vertical portion 15a is engaged with the fixing hole 100 of the side plate 11b. At this time, the horizontal portion 15b is fitted to an upper surface of the optical film group 13, and the vertical portion 15a is perpendicular to the bottom plate 11a and fits to the surface of the bottom plate 11a. Finally, a light shielding adhesive tape 16 is adhered to the outer side of the vertical portion 15a and the bottom of the bottom plate 11a to obtain the backlight module 1.

The display module 2 according to the present embodiment includes a lower polarizer 21, a display assembly 22 and an upper polarizer 23 sequentially stacked from bottom to top. The display assembly 22 is sandwiched between the upper polarizer 23 and the lower polarizer 21. One end of the display assembly 22 is attached to the surface of the top plate 11c, and the other end of the display assembly 22 is attached to the surface of the rubber strip 15. The upper polarizer 23 and the lower polarizer 21 are configured for converting the emergent light and the incident light of the display assembly 22 into a linearly polarized light having a predetermined polarizing direction, wherein the polarizing directions of the upper polarizer 23 and the lower polarizer 21 are perpendicular to each other.

It should be understood that, the above embodiment is only used to illustrate the technical concept and feature of the present invention, and the purpose thereof is familiarize the person skilled in the art to understand the content of the present invention and carry it out, which cannot restrict the protection scope of the present invention based on above. Any equivalent transformation or modification made in the spirit of the present invention should all be included within the protection scope of the present invention.

What is claimed is:

1. A backlight module, comprising: a back plate, a light guide plate, an optical film group and a light source, wherein the back plate comprises a bottom plate, the light guide plate and the optical film group are sequentially disposed on the bottom plate from bottom to top, the light source comprises a plurality of LED lamps disposed on the bottom plate and opposite to a light entrance surface of the light guide plate, and one surface of the bottom plate facing the light guide plate is coated with a reflective material.

2. The backlight module according to claim 1, wherein the back plate further comprises a side plate extending upwardly from the bottom plate, one side of the side plate afar from the light entrance surface of the light guide plate having an opening shape.

3. The backlight module according to claim 2, wherein the back plate further comprises a top plate extending from the side plate towards the optical film group, the top plate extends to one edge of the optical film group and fits to an upper surface of the optical film group.

4. The backlight module according to claim 3, wherein surfaces of the side plate and the top plate facing the light guide plate are coated with shading material.

5. The backlight module according to claim 3, further comprising a rubber strip disposed on the bottom plate, the rubber strip and the light source are respectively disposed at two opposite sides of the light guide plate.

6. The backlight module according to claim 5, wherein the rubber strip comprises a vertical portion perpendicular to the bottom plate and a horizontal portion extending from the vertical portion towards the optical film group, and the horizontal portion extends to the edge of the optical film group and is attached to the upper surface of the optical film group.

7. The backlight module according to claim 6, wherein the side plate is provided with a fixing hole, the vertical portion is formed with a bump corresponding to the fixing hole, and the rubber strip and the side plate are fixed by the bump and the fixing hole.

8. The backlight module according to claim 1, wherein a plurality of baffles are disposed at intervals on the light entrance surface of the light guide plate, the baffles and the side plate jointly define a plurality of placing slots, and the LED lamps are correspondingly accommodated in the placing slots.

9. The backlight module according to claim 2, wherein a plurality of baffles are disposed at intervals on the light entrance surface of the light guide plate, the baffles and the side plate jointly define a plurality of placing slots, and the LED lamps are correspondingly accommodated in the placing slots.

10. The backlight module according to claim 3, wherein a plurality of baffles are disposed at intervals on the light entrance surface of the light guide plate, the baffles and the side plate jointly define a plurality of placing slots, and the LED lamps are correspondingly accommodated in the placing slots.

11. The backlight module according to claim 5, wherein a plurality of baffles are disposed at intervals on the light entrance surface of the light guide plate, the baffles and the side plate jointly define a plurality of placing slots, and the LED lamps are correspondingly accommodated in the placing slots.

12. The backlight module according to claim 6, wherein a plurality of baffles are disposed at intervals on the light entrance surface of the light guide plate, the baffles and the side plate jointly define a plurality of placing slots, and the LED lamps are correspondingly accommodated in the placing slots.

13. The backlight module according to claim 7, wherein a plurality of baffles are disposed at intervals on the light entrance surface of the light guide plate, the baffles and the side plate jointly define a plurality of placing slots, and the LED lamps are correspondingly accommodated in the placing slots.

14. A method for assembling a backlight module, wherein the backlight module comprises a back plate, a light guide plate, an optical film group and a light source, the back plate comprises a bottom plate, the light guide plate and the optical film group are sequentially disposed on the bottom plate from bottom to top, the light source comprises a plurality of LED lamps disposed on the bottom plate and opposite to a light entrance surface of the light guide plate, one surface of the bottom plate facing the light guide plate is coated with a reflective material, the back plate further comprises a side plate extending upwardly from the bottom plate, one side of the side plate afar from the light entrance surface of the light guide plate has an opening shape, the back plate further comprises a top plate extending from the side plate towards the optical film group, the top plate extends to an edge of the optical film group and fits to an upper surface of the optical film group, the method comprising the steps of:
attaching the light source and the optical film group to the light guide plate to form a first component; and
inserting the first component into the back plate from one side of the back plate having the opening shape to form the backlight module.

15. A liquid crystal display, comprising a display module and a backlight module, wherein the backlight module comprises a back plate, a light guide plate, an optical film group and a light source, the back plate comprises a bottom plate, the light guide plate and the optical film group are sequentially disposed on the bottom plate from bottom to top, the light source comprises a plurality of LED lamps disposed on the bottom plate and opposite to a light entrance surface of the light guide plate, one surface of the bottom plate facing the light guide plate is coated with a reflective material, and the display module is positioned above the optical film group.

16. The liquid crystal display according to claim 15, wherein the back plate further comprises a side plate extending upwardly from the bottom plate, one side of the side plate afar from the light entrance surface of the light guide plate has an opening shape.

17. The liquid crystal display according to claim 16, wherein the back plate further comprises a top plate extending from the side plate towards the optical film group, and the top plate extends to one edge of the optical film group and fits to an upper surface of the optical film group.

18. The liquid crystal display according to claim 17, further comprising a rubber strip disposed on the bottom plate, and the rubber strip and the light source are respectively disposed at two opposite sides of the light guide plate.

19. The liquid crystal display according to claim 18, wherein the rubber strip comprises a vertical portion perpendicular to the bottom plate and a horizontal portion extending from the vertical portion towards the optical film group, and the horizontal portion extends to one edge of the optical film group and is fitted to an upper surface of the optical film group.

20. The liquid crystal display according to claim 19, wherein the side plate is provided with a fixing hole, the vertical portion is formed with a bump corresponding to the fixing hole, and the rubber strip and the side plate are fixed by the bump and the fixing hole.
